(19) United States
(12) Patent Application Publication
(10) Pub. No.: US 2014/0220538 A1
(43) Pub. Date: Aug. 7, 2014

(54) AUDIENCE RESPONSE SYSTEM DATA COMMUNICATION INCORPORATING NON USER SELECTION SIGNALS

(71) Applicant: Turning Technologies, LLC, Youngstown, OH (US)

(72) Inventor: Jonathan A. Hallsten, Barberton, OH (US)

(73) Assignee: Turning Technologies, LLC, Youngstown, OH (US)

(21) Appl. No.: 14/252,208

(22) Filed: Apr. 14, 2014

Related U.S. Application Data
(63) Continuation of application No. 12/852,703, filed on Aug. 9, 2010, now abandoned.

(51) Int. Cl. G09B 7/00

(52) U.S. Cl. CPC G09B 7/00
USPC 434/351

(57) ABSTRACT

A method for a response device to wirelessly communicate data in an audience response system having a plurality of response devices includes transmitting a first signal, receiving a first acknowledgement signal indicating to the response device to transmit non user selection signals. The method further includes transmitting a non user selection signal in response to the first acknowledgement signal and receiving a second acknowledgement signal indicating to the response device to cease transmitting non user selection signals.

### FIELD OF THE INVENTION

The present application relates to an audience response system. More particularly, the present application relates to devices and methods for implementing data communication incorporating non user selection signals.

### BACKGROUND

Audience response systems have been employed for users to communicate their responses to audience response questions. Such systems may be used in classroom settings, corporate meetings, or in other gatherings. These systems may include a base unit or host computer running the audience response session and a plurality of response devices. The response devices receive user selections and transmit signals encoding the user selections.

### SUMMARY OF THE INVENTION

A method for a response device to wirelessly communicate data in an audience response system having a plurality of response devices includes transmitting a first signal, receiving a first acknowledgement signal indicating to the response device to transmit non user selection signals. The method further includes transmitting a non user selection signal in response to the first acknowledgement signal and receiving a second acknowledgement signal indicating to the response device to cease transmitting non user selection signals.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a schematic of an exemplary audience response system.

FIG. 2 illustrates a front view of an exemplary embodiment of a response device in an audience response system.

FIG. 3 illustrates an exemplary block diagram of a response device in an audience response system.

FIG. 4 illustrates a flow chart an exemplary method for a response device in an audience response system having a plurality of response devices to wirelessly communicate data.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Data communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

“Audience response system,” as used herein, includes but is not limited to systems for interaction between audience members and an entity or entities that collect responses from the audience members. Audience members may be collocated or remote from each other or from an entity collecting the responses. Audience response systems may be used in conjunction with presentation software or may be used without presentation software. Audience response systems may take the form of a base as the entity collecting the responses and wired or wireless devices as the means for users to select their responses to the questions presented. Audience response systems may also take the form of interactive whiteboards where a whiteboard may be used as the means for users to select their responses to the questions presented.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it should be appreciated that throughout the description, terms like processing, computing, calculating, determining, displaying, or the like, refer to actions and processes of a computer system, logic, processor, or similar electronic device that manipulates and transforms data represented as physical (electronic) quantities.

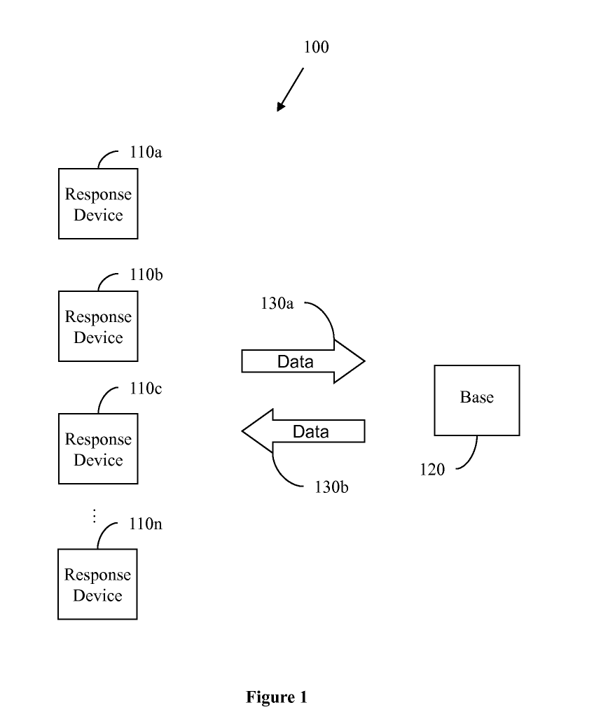

FIG. 1 illustrates a schematic of an exemplary audience response system 100. System 100 includes a plurality of response devices 110a-n. Although four response devices are shown, it should be understood that an audience response system may have as few as one response device or as many as hundreds, or even thousands, of response devices. The response devices may be handheld devices, or may be embedded in a stationary object, such as a chair or desk. The response devices may also be any other devices capable of communicating in an audience response system such as computers (e.g. laptop, PC, tablet, and so on), mobile phones, smart phones, etc. The response devices may be dedicated devices or may be multi-task devices.

The system 100 also includes at least one base 120. The base 120 receives data 130a from the response devices 110a-n and the base 120 transmits data 130b to the response devices 110a-n. The response devices may be handheld devices, or may be embedded in a stationary object, such as a chair or desk. The response devices may also be computers. The response devices may be dedicated devices or may be multi-task devices.The base 120 may be a computer (e.g. laptop, PC, tablet, and so on), multiple computers, a device connected to a computer, a device independent from a computer, and so on. Although a single base is shown, it should be understood that an audience response system may include several bases. In systems with multiple bases, each base may be configured to communicate with preselected response devices. Alternatively, each base may be configured to communicate with any response device.

In the illustrated embodiment, the response devices 110a-n and the base 120 communicate data 130a-b wirelessly. In one embodiment, the response devices 110a-n and the base 120 transmit and receive radio frequency (RF) signals encoding the data. In an alternative embodiment, the response devices 110a-n and the base 120 transmit and receive infrared (IR) signals encoding the data.

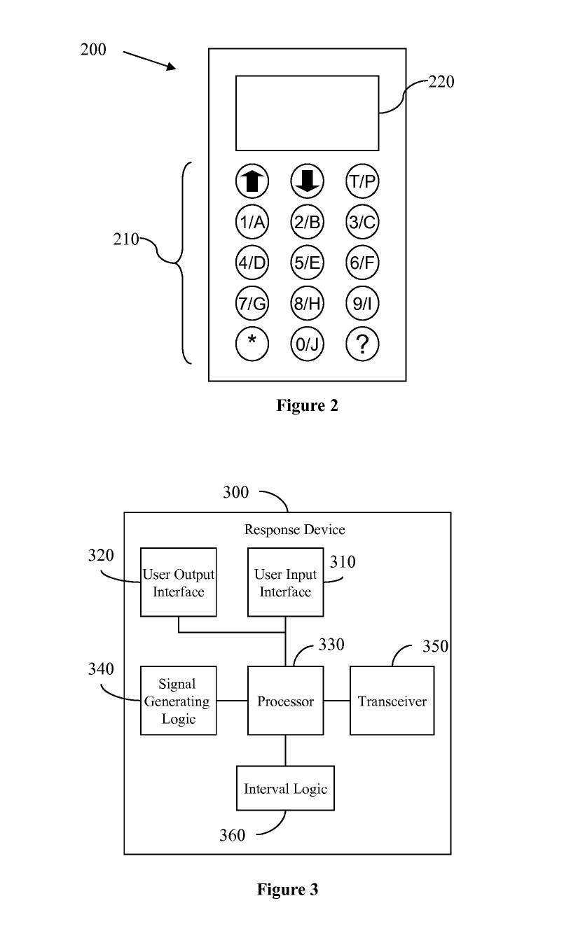

FIG. 2 illustrates a front view of an exemplary embodiment of a response device 200. The response device 200 is an exemplary embodiment of the response devices 110 shown in FIG. 1. The response device 200 communicates wirelessly in an audience response system, such as system 100 described above, having a plurality of response devices. The device 200 includes a keypad 210 and a display 220. In alternative embodiments, other inputs may be employed, such as touch screens, dials, knobs, click wheels, roller balls, and roller pads. Similarly, other outputs may be employed, such as LED indicators. In other embodiments, the response device does not include a display.

In the illustrated embodiment, the keypad 210 includes a plurality of alpha-numeric keys and additional function keys for a user to enter information including responses to audience response questions during a polling or test session. A user may also use the keypad 210 to enter other types of information including log-in or sign-in information, setup information, administrative information regarding a polling or testing session, and so on. In other embodiments, the keypad may include keys in other formats other than alpha-numeric or the keypad may include a touch screen.

In alternative embodiments, other input devices may be employed instead of a keypad. Exemplary input devices include touch screens, click wheels, roller balls, dials, knobs, and switches.

In the illustrated embodiment, the display 220 is a liquid crystal display (LCD) configured to display various information related to audience response sessions (e.g. unit ID, user ID, question ID, response entered, response received, time left in the session, time left to answer a question, and so on). The display 220 may also display device status information (e.g. on/off, battery life, transmission channel, and so on).

In alternative embodiments, other output devices may be employed instead of an LCD. Exemplary output devices include touch screens and light emitting diodes (LED).

FIG. 3 illustrates an exemplary block diagram illustrating components of a response device 300. It should be understood that the device 300 may be the same as device 200 of FIG. 2. However, device 300 is not limited to such a configuration. Device 300 includes a user input interface 310. The user input interface 310 receives user selections. A user selection may take the form of a key press in an alpha-numeric keypad such as keypad 210 described above. Thus, the user input interface 310 may take the form of the alpha-numeric keypad 210. The user input interface 310 may also take the form of various other user input interfaces (e.g. pointing device, wheel, soft keys, combinations thereof, and so on).

The device 300 further includes a user output interface 320. The user output interface 320 may take the form of a display such as display 220 discussed above. The user output interface 320 may also take the form of various other user output interfaces (e.g. light emitting diodes (LED), LED displays, liquid crystal displays (LCD), combinations thereof, and so on).

The device 300 also includes a processor 330. The processor 330 operably connects to the user input interface 310 and the user output interface 320. The processor 330 receives from the user input interface 310 data representing the user selections.

The device 300 further includes a signal generating logic 340. The signal generating logic 340 operably connects to the processor 330. The signal generating logic 340 generates signals encoding information for transmission in the audience response system. While FIG. 3 shows the signal generating logic 340 as separate from the processor 330, it should be understood that the signal generating logic 340 may be a part of the processor 330.

The signal generating logic 340 is configured to generate user selection signals. After a user inputs a selection through the user input interface 310, data representing the user selection is transmitted to the processor 330. The processor 330 then transmits the data representing the user selection to the signal generating logic 340. In one embodiment, the processor 330 transmits data upon receipt. In an alternative embodiment, the processor 330 accumulates data related to multiple user selections before transmitting the data to the signal generating logic 340 or the signal generating logic 340 accumulates data related to multiple user selections upon receipt from the processor 330. The signal generating logic 340 then generates a user selection signal. A user selection signal would commonly encode data representing the user selection or multiple user selections.

The signal generating logic 340 is also configured to generate non user selection signals. A non user selection signal is a signal generated not in response to a user selection. For example, a non user selection signal may include data where the response device 300 queries the base as to whether the response device 300 should remain in or exit a mode of operation.

The device 300 also includes a transceiver 350 which operably connects to the processor 330. The transceiver 350 transmits the signals generated by the signal generating logic 340. The transceiver 350 also receives acknowledgement signals. Another device in the audience response system (for example the base 120 discussed above) transmits the acknowledgement signals in response to signals transmitted by the transceiver 350. For every signal transmitted by the transceiver 350, a corresponding acknowledgment signal is expected. The transceiver 350 repeats transmission of a signal until the transceiver 350 receives the corresponding acknowledgment signal, until a predetermined number of retransmissions is reached, or until a predetermined time for receipt of the corresponding acknowledgment signal expires.

Although the transceiver 350 is illustrated as separate from the processor 330, it should be understood that the transceiver 350 and processor 330 may be part of the same component. In an alternative embodiment (not shown), the device 330 may include a transmitter and a separate receiver instead of a transceiver.

In one embodiment, the transceiver 350 receives an acknowledgement signal encoding data indicating to the response device 300 to transmit subsequent non user selection signals. In response, the signal generating logic 340 generates non user selection signals and the transceiver 350 transmits the non user selection signals. The response device 300 receives acknowledgement signals corresponding to each of the non user selection signals transmitted. The signal generating logic 340 generates non user selection signals and the transceiver 350 transmits the non user selection signals until the transceiver 350 receives an acknowledgement signal encoding data indicating to the response device 300 not to transmit subsequent non user selection signals.

During the period between the time when the transceiver 350 receives the acknowledgement signal encoding data indicating to the response device 300 to transmit subsequent non user selection signals until the time when the transceiver 350 receives the acknowledgement signal encoding data indicating to the response device 300 not to transmit subsequent non user selection signals, the user input interface 310 can receive user selections, the signal generating logic 340 can generate user selection signals, and the transceiver 350 can transmit the user selection signals and receive acknowledgement signals corresponding to the user selection signals.

In one embodiment, an acknowledgement signal encoding data indicating to the response device 300 to transmit subsequent non user selection signals also encodes data representing a length of time remaining in a session or a length of time left for a user to make user selections. In this embodiment, the user output interface 320 may be configured to indicate the length of time remaining in the session or the length of time left for the user to make user selections.

In another embodiment, after receipt of an acknowledgement signal indicating to the response device 300 not to transmit subsequent non user selection signals, the processor 330 transmits instructions to the user output interface 320 to display information indicating to the user that time for making user selections has expired or that user selections are no longer accepted.

The response device 300 further includes an interval logic 360, which operably connects to the processor 330. The interval logic 360 indicates time intervals for transmission of signals including subsequent non user selection signals. Although the transceiver 350 is illustrated as separate from the processor 330, it should be understood that the transceiver 350 and processor 330 may be part of the same component.

In one example, the transceiver 350 transmits a first non user selection signal. After expiration of a first time interval generated by interval logic 360, the transceiver 350 transmit a second non user selection signal. After expiration of a second time interval, the transceiver 350 transmit a third non user selection signal, and so on. In one embodiment, time intervals are measured from the time of transmission of non user selection signals. In another embodiment, time intervals are measured from receipt of acknowledgement signals corresponding to the transmitted non user selection signals.

In one embodiment, the interval logic 360 generates time intervals for transmission of subsequent non user selection signals that are of the same time length. In another embodiment, the interval logic 360 generates time intervals that are of different time lengths. In one embodiment, the interval logic 360 generates time intervals whose lengths are selected at random or at random from a range practical time lengths (e.g. microseconds, seconds, minutes, and so on) or from a set of discrete time lengths.

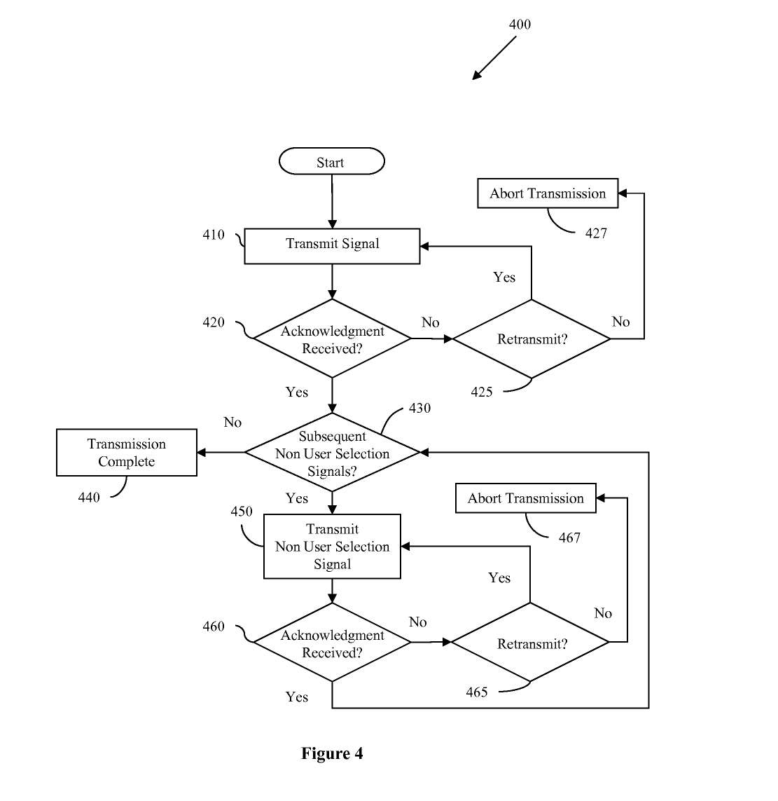

Example methods may be better appreciated with reference to the flow diagram of FIG. 4. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagram of FIG. 4, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform the method of FIG. 4. While the method is described being provided on a computer-readable medium, it is to be appreciated that other example methods described herein can also be provided on a computer-readable medium.

While FIG. 4 illustrates various actions occurring serially, it is to be appreciated that various actions illustrated in FIG. 4 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 4 illustrates a flow chart for an exemplary method 400 for a response device in an audience response system having a plurality of response devices to wirelessly communicate data. At 410, the response device transmits a signal. The signal could be a user selection signal or a non user selection signal. At 420, if an acknowledgement signal is not received within a time interval, the method 400 moves to 425 to determine whether to retransmit the signal. Step 425 may determine whether to retransmit the signal based on a number of repeated transmissions of the signal without receiving the acknowledgement signal, or expiration of a time limit after the first transmission of the signal or some other time period. If the number of repeated transmissions or the time limit or time period has been reached, the response device declares failure in the transmission of the signal and aborts transmission at 427. If the number of repeated transmissions or the time limit or time period has not been reached, the method 400 returns to 410 to retransmit the signal.

At 420, if the acknowledgement signal is received, at 430, the response device determines whether the acknowledgement signal encodes data indicating to the response device to transmit subsequent non user selection signals.

If the acknowledgement signal does not encode data indicating to the response device to transmit subsequent non user selection signals, at 440, the response device declares that the transmission is complete. If the acknowledgement signal encodes data indicating to the response device to transmit subsequent non user selection signals, at 450, the response device transmits a non user selection signal. At this point, the method 400 may run two parallel tasks: one transmitting user selection signals and another transmitting non user selection signals. Thus, transmissions of user selection signals may intersperse transmissions of non user selection signals.

At 460, if an acknowledgement signal is not received within a time interval, the method 400 moves to 465 to determine whether to retransmit the signal. Step 465 may determine whether to retransmit the signal based on a number of repeated transmissions of the signal without receiving the acknowledgement signal, or expiration of a time limit after the first transmission of the signal or some other time period. If the number of repeated transmissions or the time limit or time period has been reached, the response device declares failure in the transmission of the signal and aborts transmission at 467. If the number of repeated transmissions or the time limit or time period has not been reached, the method 400 returns to 450 to retransmit the signal.

If the acknowledgement signal is received, the method 400 returns to 430 to determines whether the acknowledgement signal encodes data indicating to the response device to transmit subsequent non user selection signals.

In one exemplary application, the device 300 and the method 400 may be used to transmit a response to a timed audience response question whose response includes multiple characters. For example, an audience response question may be: “what is the value of pi to two decimal points?” and the user may have 10 seconds to respond.

The response requires a user to select multiple characters (i.e., “3”, “.”,“1” and “4”). When the user selects the number 3, the first character from the multiple character response, the response device receives the user selection and transmits a signal. In response to the signal, the response device receives an acknowledgement signal indicating to the response device to transmit subsequent non user selection signals. From that point on, the device transmits non user selection signals at time intervals and receives acknowledgement signals in response. In one embodiment, the device transmits a non user selection signal once a second. In other embodiments, the device transmits non user selection signals at intervals other than once a second. In one embodiment, the acknowledgement signals may also indicate the time left to answer the question and a display in the response device may display the time left for the user to see.

The user can continue to enter the remaining characters in the response. The response device may transmit characters encoded in user selection signals one character at a time as the user selects the characters. The response device may instead transmit the characters all at once after the user has selected a carriage return key or after the time for responding expires.

When the time for responding has expired (i.e., the 10 seconds to respond in this example), the response device receives, in response to either a user selection signal or a non user selection signal, an acknowledgement signal indicating to the response device not to transmit subsequent non user selection signals. A display on the response device may indicate to the user that the time to answer the question has expired or that responses are no longer accepted.

The person of ordinary skill in the art would understand that the devices and methods disclosed above have applications beyond this exemplary application.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2 d. Ed. 1995).

1. A method for wirelessly communicating data to a base from a response device of an audience response system comprising a plurality of response devices, the method comprising:
a response device transmitting, via a transceiver, a first signal;
the response device receiving, with a transceiver, a first acknowledgement signal from the base, where the first acknowledgement signal indicates that the base expects a non user selection signal from the response device;
the response device transmitting, via a transceiver associated with the response device, a non user selection signal in response to the first acknowledgement signal; and
the response device receiving, with a transceiver, a second acknowledgement signal from the base, where the second acknowledgement signal indicates that the base no longer expects a non user selection signal from the response device.

2. The method of claim 1, where the transmitting of the non user selection signal and any subsequent non user selection signals occur at time intervals, and where the time intervals have different lengths of time.

3. The method of claim 1, where the first signal is a first user selection signal.

4. The method of claim 3, further comprising:
the response device transmitting a second user selection signal, where the first user selection signal includes data representing at least a first character from multiple characters, and where the second user selection signal includes data representing at least a second character from the multiple characters.

5. The method of claim 3, further comprising:
the response device including, via a processor, data representing two or more characters from multiple characters in a second user selection signal; and
the response device transmitting the second user selection signal after receiving a carriage return user selection.

6. The method of claim 1, further comprising:
the response device including, via a processor, data representing multiple user selections in a third signal; and
the response device transmitting the third signal after receiving the second acknowledgement signal.

7. The method of claim 1, where the first signal is a second non user selection signal, and where the transmitting of the non user selection signal occurs upon expiration of a first time interval after the transmitting of the first signal.

8. The method of claim 7, further comprising:
the response device transmitting a third non user selection signal upon expiration of a second time interval after the transmitting of the non user selection signal, where the first time interval and the second time interval have the same time length.

9. The method of claim 7, further comprising:
the response device transmitting a third non user selection signal upon expiration of a second time interval after the transmitting of the non user selection signal, where the first time interval and the second time interval have different time lengths.

10. The method of claim 7, further comprising:
the response device transmitting a third signal upon expiration of a second time interval after the transmitting of the non user selection signal, where the first time interval and the second time interval have different time lengths and the first time interval and the second time interval are selected at random or at random from a plurality of time lengths.

11. The method of claim 1, further comprising:
the response device indicating that user selections are no longer accepted after receiving the second acknowledgement signal.

12. The method of claim 1, further comprising:
the response device indicating a length of time after receipt of the first acknowledgement signal, where the first acknowledgement signal encodes data representing the length of time.

13. The method of claim 1, wherein the first acknowledgement signal indicates that the base expects multiple non user selection signals from the response device, and wherein the response device transmits, via a transceiver associated with the response device, multiple non user selection signals in response to the first acknowledgement signal.
